(19) United States
(12) Patent Application Publication
(10) Pub. No.: US 2023/0155543 A1
(43) Pub. Date: May 18, 2023

(54) SOLAR CELL MODULE INCLUDING REFLECTION PLATE AND METHOD FOR ADJUSTING REFLECTION MODULE

(71) Applicant: NANOVALLEY CO., LTD., Daejeon (KR)

(72) Inventor: Young-kwon JUN, Pohang-si (KR)

(21) Appl. No.: 17/424,213

(22) PCT Filed: Mar. 24, 2021
(86) PCT No.: PCT/KR2021/003627

§ 371 Date: Jul. 20, 2021

(30) Foreign Application Priority Data
Apr. 7, 2020 (KR) 10-2020-0042094
Feb. 8, 2021 (KR) 10-2021-0017223

(51) Int. Cl. H02S 40/22; H02S 20/32

(52) U.S. Cl. CPC H02S 40/22; H02S 20/32; H02S 30/20

(57) ABSTRACT

The present invention is intended to prevent shadow by a reflection plate, which may be generated according to a solar path variation, to increase a power generation efficiency of a solar cell module. To achieve the objects, one aspect of the present invention includes a solar cell panel and a reflection plate connected to and disposed on an edge of the solar cell pane, and angles between the reflection plates and a surface of the panel is simultaneously or individually varied.

### TECHNICAL FIELD

The present invention relates to a solar cell module including a solar cell panel and a reflection plate and a method for adjusting the reflection plate.

### BACKGROUND ART

In general, a solar cell module is completed through a process of connecting electrode wires of cells by using a copper ribbon and laminating and pressing in an order of a back sheet, ethylene-vinyl acetate (EVA), a solar cell, EVA, and a cover glass, a process of finishing an edge of the pressed laminate with an aluminum frame, and a process of installing a junction box for connecting the copper ribbon to an output cable.

Typically, the solar cell module is installed without a reflection plate, or even when the reflection plate is provided, the reflection plate is arranged to form a predetermined angle with a solar cell panel. Since an incident angle of solar light is continuously varied as time elapses while the reflection plate arranged as described above is fixed, a reflection effect of the reflection plate may be varied according to time, the effect of the reflection plate may be limited to a specific time zone, and even shadow may be generated on the solar cell panel by the reflection plate to degrade a power generation efficiency.

### RELATED ART DOCUMENT

Korean Patent Registration No. 0090752

### DISCLOSURE OF THE INVENTION

### Technical Problem

An object of present invention is to provide a solar cell module preventing shadow by a reflection plate, which may be generated according to a solar path variation, to improve a power generation efficiency and a method for adjusting the reflection plate of the solar cell module.

Another object of present invention is to provide a solar cell module capable of increasing a power generation quantity per each installation area and/or per each solar cell panel to allow an efficient and economical solar cell power generation.

### Technical Solution

In a first aspect of the present invention to achieve the objects, a solar cell module includes a solar cell panel and a reflection plate connected to and disposed on an edge of the solar cell panel, and an angle between the reflection plate and a surface of the panel is varied.

As described above, the angle between the reflection plate connected to and disposed on the solar cell panel and the solar cell panel may be varied according to a solar path variation to increase a solar-light power generation efficiency.

In the first aspect of the present invention, the reflection plate may include a first reflection plate disposed at the east and a second reflection plate disposed at the west when the panel faces the south, and an angle between a surface of the panel and a surface of the first reflection plate and an angle between the surface of the panel and a surface of the second reflection plate may be simultaneously or individually varied.

In the first aspect of the present invention, the angle between the reflection plate and a surface of the panel may be varied along a solar path variation.

In the first aspect of the present invention, the angle between the reflection plate and the surface of the panel may be varied in a range from 60° to 180°.

The solar cell panel of the present invention may be disposed to face the south. For example, the first reflection plate disposed at the east is parallel to the panel and completely unfolded to form 180° at the time of sunrise, and the second reflection plate disposed at the west that is the opposite side may be inclined by 60° to the panel to concentrate the solar light. When the angle is less than 60°, an area receiving the solar light may be excessively small.

In the first aspect of the present invention, the reflection plate has a width greater than that of the panel. As the width of the reflection plate is formed to be greater than the width of the panel, a reflection quantity may increase to increase the power generation efficiency.

In the first aspect of the present invention, the reflection plate may include one or both of a third reflection plate connected to and disposed on an upper edge of the panel and a fourth reflection plate connected to and disposed on a lower edge of the panel.

As the reflection plate is connected to and disposed on the upper edge and/or the lower edge in addition to both sides of the solar cell module, a reflection rate may increase to increase the solar-light power generation efficiency.

In the first aspect of the present invention, an angle between the surface of the panel and a surface of the third reflection plate and an angle between the surface of the panel and a surface of the fourth reflection plate may be simultaneously or individually varied.

In the first aspect of the present invention, the solar cell module may further include an illuminance sensor, and as a motor configured to vary the angle is connected to the reflection plate, the motor may be driven to rotate the reflection plate so that illuminance is maximized by using the illuminance sensor.

Particularly, while an internal angle α5 between the first reflection plate and the second reflection plate is maintained to be 60°, and maximum illuminance is maintained by the illuminance sensor, the angle of each of the first reflection plate and the second reflection plate may be adjusted. As the angle α1 and α2 formed with the panel according to the solar path variation while maintaining the internal angle between the first reflection plate and the second reflection plate to be constant, a power generation quantity may be maximized. As described above, as the internal angle is constantly maintained, the first and second reflection plates may be symmetric to incident light when the solar path is varied, and an incident angle and an incident quantity of the solar light incident to the surface of the panel may be uniformly adjusted and optimized to increase the power generation quantity.

In a second aspect of the present invention to achieve the objects, a method for adjusting the reflection plate of the solar cell module according to the first aspect includes adjusting the angle between the reflection plate and the surface of the panel so that solar light is always incident to a surface of the reflection plate.

When shadow is generated by the reflection plate according to the solar path variation, the solar cell efficiency may decrease, which may be prevented by adjusting the angle of the reflection plate.

In the second aspect of the present invention, the method may further include: maintaining an angle of the surface of each of the first and second reflection plates with the surface of the panel to be 180° before 10 o'clock in the morning, maintaining an angle of the surface of each of the first and second reflection plates with the surface of the panel to be 120° from 10 o'clock in the morning to 2 o'clock in the afternoon, and maintaining an angle of the surface of each of the first and second reflection plates with the surface of the panel to be 180° after 2 o'clock in the afternoon.

In the second aspect of the present invention, the method may further include: maintaining an angle of the first reflection plate with the surface of the panel to be 180° and an angle of the second reflection plate with the surface of the panel to be 120° before 10 o'clock in the morning, maintaining an angle of each of the first and second reflection plates with the surface of the panel to be 120° from 10 o'clock in the morning to 2 o'clock in the afternoon, and maintaining an angle of the first reflection plate with the surface of the panel to be 120° and an angle of the second reflection plate with the surface of the panel to be 180° after 2 o'clock in the afternoon.

In the second aspect of the present invention, the angle between the reflection plate and the surface of the panel may be adjusted so that an internal angle between the first reflection plate and the second always forms 60°, and the solar light is always incident to the surface of the reflection plate.

In a third aspect of the present invention to achieve the objects, two or more solar cell panels may be provided, and the reflection plate may be disposed at one side or both sides of the solar cell panels in a direction crossing a virtual central line between the two or more solar cell panels.

In a fourth aspect of the present invention to achieve the objects, two or more solar cell panels may be provided, the two or more solar cell panels may be arranged to face each other such that a solar-light incident surface of one solar cell panel is inclined at a predetermined angle to a solar-light incident surface of another solar cell panel, the reflection plate may be disposed at one side or both side of the solar cell panels facing each other in a direction crossing a virtual central line between the solar cell panels facing each other.

In the third aspect or fourth aspect of the present invention, the solar cell module may further include a reflection plate disposed on one or all of both edges of the two or more solar cell panels that are consecutively arranged in a direction parallel to the virtual central line.

In the fourth aspect of the present invention, the predetermined angle may be greater than 0° and less than 180°.

In the fourth aspect of the present invention, in the two or more solar cell panels, one ends of two adjacent solar cell panels may be connected through a connection shaft, and the reflection plates arranged in the direction crossing the virtual central line may contact each other at the connection shaft or be spaced a predetermined distance from each other.

In the third aspect or fourth aspect of the present invention, the two or more solar cell panels may include a support configured to support the reflection plate.

In the third aspect or fourth aspect of the present invention, the two or more solar cell panels may be connected in the form of ∧ or ∨, and as the solar cell panels connected in the form of ∧ or ∨ are arranged so that one of the ∧ shape and the ∨ shape is consecutively arranged or both of the ∧ shape and the ∨ shape are mixed, the solar-light incident surfaces may face each other.

In the third aspect or fourth aspect of the present invention, the reflection plate may be additionally disposed on a portion connected in the form of ∧ or ∨.

In the third aspect or fourth aspect of the present invention, the reflection plate may have a shape of one of a flat surface, a curved surface, or a bent surface, or a combination thereof.

In the third aspect or fourth aspect of the present invention, the solar cell module may further include an angle adjusting unit configured to adjust an inclination of the reflection plate.

### Advantageous Effects

The solar cell module including the reflection plate and the method for adjusting the reflection plate according to an embodiment of the present invention may prevent the shadow by the reflection plate, which is generated according to the solar path variation, to increase the power generation efficiency of the solar cell module.

The solar cell module according to another embodiment of the present invention may allow the solar light reflected by the adjacent solar cell panels or reflection plates to be re-absorbed in addition to the solar light directly incident to the panel through the arrangement of the solar cell panels and various reflection plates to achieve the efficient and economical solar cell power generation.

### BRIEF DESCRIPTION OF THE DRAWINGS

FIG. 1 is a schematic view of a solar cell module according to a first embodiment of the present invention.

FIG. 2 is a view for explaining an angle variation of a reflection plate in the solar cell module according to the first embodiment of the present invention.

FIG. 3 is a schematic view of a solar cell module according to a second embodiment of the present invention.

FIG. 4 is a view for explaining an angle variation of a reflection plate according to a solar path variation in a solar cell module according to a fifth embodiment of the present invention.

FIG. 5 is a view for explaining an angle variation of a reflection plate according to a solar path variation in a solar cell module according to a sixth embodiment of the present invention.

FIG. 6 is a view for explaining an angle variation of a reflection plate according to a solar path variation in a solar cell module according to a seventh embodiment of the present invention.

FIG. 7 is a plan view and a side view of a solar cell module according to an eighth embodiment of the present invention.

FIG. 8 is a perspective view of the solar cell module according to the eighth embodiment of the present invention.

FIG. 9 is a view exemplarily illustrating a shape of a reflection plate attached to the solar cell module.

FIG. 10 is a view illustrating a state in which a solar cell module according to the eighth embodiment of the present invention is installed on a structure such as a fence.

FIG. 11 is a plan view and a side view of a solar cell module according to a ninth embodiment of the present invention.

FIG. 12 is a perspective view of a solar cell module according to the ninth embodiment of the present invention.

FIG. 13 is a view illustrating a state in which the solar cell module according to the ninth embodiment of the present invention is installed on a structure such as a fence.

FIG. 14 is a plan view and a side view of a solar cell module according to a tenth embodiment of the present invention.

FIG. 15 is a plan view and a side view of a solar cell module according to an eleventh embodiment of the present invention.

FIG. 16 is a side view of a solar cell module according to a twelfth embodiment of the present invention.

FIG. 17 is a side view of a solar cell module according to a thirteenth embodiment of the present invention.

### MODE FOR CARRYING OUT THE INVENTION

Hereinafter, the configuration and effects of embodiments of the present invention will be described with reference to the accompanying drawings.

Hereinafter, detailed descriptions related to well-known functions or configurations will be ruled out in order not to unnecessarily obscure subject matters of the present invention. Furthermore, when it is described that one comprises (or includes or has) some elements, it should be understood that it may comprise (or include or has) only those elements, or it may comprise (or include or have) other elements as well as those elements if there is no specific limitation.

### First Embodiment

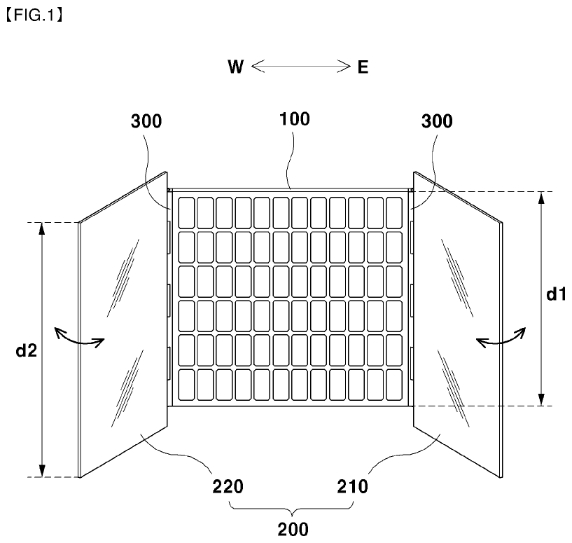

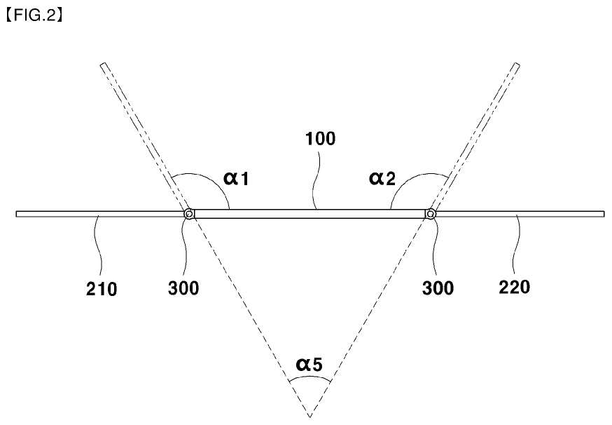

FIG. 1 is a schematic view of a solar cell module according to a first embodiment of the present invention, and FIG. 2 is a view for explaining an angle variation of a reflection plate in the solar cell module according to the first embodiment of the present invention.

Referring to FIGS. 1 and 2, the solar cell module according to the first embodiment of the present invention includes a solar cell panel 100 having a rectangular shape, a first reflection plate 210 and a second reflection plate 220, which are disposed on both edges of the solar cell panel 100, respectively, and an angle adjusting device 300 adjusting and fixing an angle of each of the first reflection plate 210 and the second reflection plate 220 with respect to the solar cell panel 100.

An angle α1 and α2 between the solar cell panel 100 and each of the first reflection plate 210 and the second reflection plate 220 may be varied, and the variable angel may be varied in a range from 60° to 180°.

The angle adjusting device 300 may manually or automatically move and have a hinge structure to rotate. Also, a friction force may be applied to be fixed at a desired angle. Although angle adjustment and fixing are made by only the hinge structure in FIG. 1, a separate fixing structure may be provided in addition to the hinge structure.

As illustrated in FIG. 2, at a side at which the solar cell panel 100 and each of the first reflection plate 210 and the second reflection plate 220 are folded, a width d2 of each of the first reflection plate 210 and the second reflection plate 220 may be greater than a width d1 of the solar cell panel 100 to increase an incident amount of solar light.

### Second Embodiment

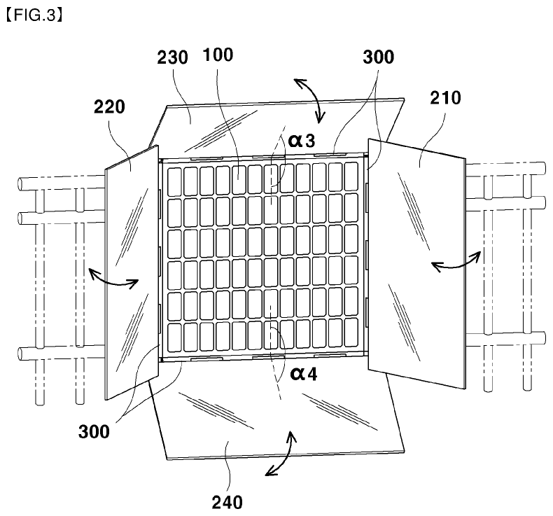

FIG. 3 is a schematic view illustrating a solar cell module according to a second embodiment of the present invention.

Referring to FIG. 3, the solar cell module according to the second embodiment of the present invention additionally include a third reflection plate 230 and a fourth reflection plate 240, which are installed on an upper portion and a lower portion of the solar cell panel 100, respectively, in addition to the first reflection plate 210 and the second reflection plate 220, which are disposed on the both sides of the solar cell panel 100, respectively. The third reflection plate 230 and the fourth reflection plate 240 may be varied with respect to the solar cell panel 100. Although the reflection plate is installed all of the upper and lower portions in FIG. 3, the reflection plate may be installed on only one of the upper and lower portions.

An angle of each of the third reflection plate 230 and the fourth reflection plate 240 with respect to the solar cell panel 100 may maintain 120° continuously during solar-light power generation. The maintaining of the angle of 120° is preferred to increase an incidence area of solar light and increase incidence of solar light to the solar cell panel 100 through reflection although shadow caused by the solar light is not generated when an angle α3 and α4 of the third reflection plate 230 and the fourth reflection plate 240 is not an acute angle.

### Third Embodiment

A solar cell module additionally includes an illuminance sensor for measuring light-sensitivity and connects each of the reflection plates 210 and 220 with a rotation motor (not shown) to rotate with respect to the solar cell panel 100 so that a signal of the illuminance sensor is applied, and the reflection plates 210 and 220 rotate by an electrical signal. Here, the rotation motor may be adjusted such that a driving shaft thereof is mechanically connected to the reflection plates 210 and 220, and applied to, e.g., a configuration according to twelfth or thirteenth embodiment below.

### Fourth Embodiment

A power generation efficiency is evaluated after the solar-light power generation is performed by using the solar cell module according to the first embodiment of the present invention as follows.

The solar cell panel 100 is arranged to face the south, the angle α1 and α2 between a top surface of each of the first reflection plate 210 and the second reflection plate 220 and a top surface of the solar cell panel 100 is maintained to be 180° before 10 o'clock, the angle between the top surface of each of the first reflection plate 210 and the second reflection plate 220 and the top surface of the solar cell panel 100 is maintained to be 120° from 10 o'clock to 14 o'clock, and the angle between the top surface of each of the reflection plates and the top surface of the panel is maintained to be 180° after 14 o'clock.

### Fifth Embodiment

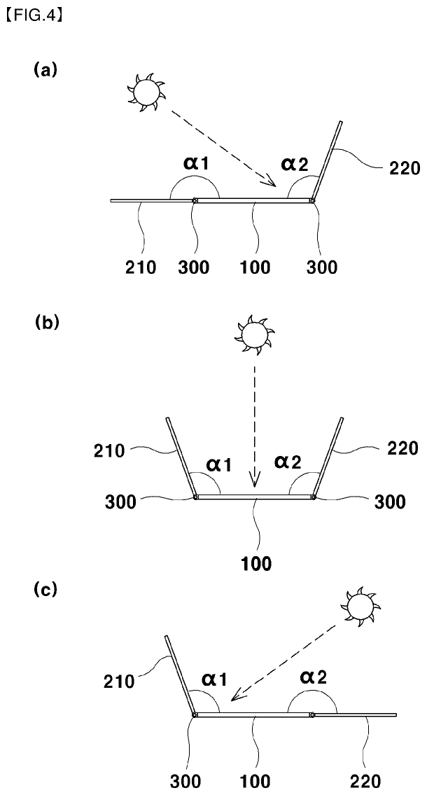

The solar cell panel 100 is arranged to face the south, the angle between the first reflection plate 210 that is disposed at the east among the reflection plates and the top surface of the solar cell panel 100 is maintained to be 180° before 10 o'clock, the angle between the second reflection plate 220 that is disposed at the west among the reflection plates and the top surface of the solar cell panel 100 is maintained to be 120°, the angle between the top surface of each of the first reflection plate 210 and the second reflection plate 220 and the top surface of the solar cell panel 100 is maintained to be 120° from 10 o'clock to 14 o'clock, the angle between the first reflection plate among the reflection plates and the top surface of the solar cell panel 100 is maintained to be 120° after 14 o'clock, and the angle between the second reflection plate among the reflection plates and the top surface of the solar cell panel is maintained to be 180° after 14 o'clock. The method for varying the angle of the reflection plate is described in FIG. 4. As illustrated in FIG. 4a, the solar-light power generation is performed by maintaining the angle α1 to be 180° because the first reflection plate 210 is completely unfolded before 10 o'clock and allowing the second reflection plate to maintain the angle α2 of 120°. Thereafter, the solar-light power generation may be performed by maintaining all of the angles α1 and α2 to be 120° from 10 o'clock to 14 o'clock, i.e., the time of the southing of the sun as illustrated in FIG. 4b and allowing the first reflection plate 210 to maintain the angle α1 of 120° and the second reflection plate 220 to have the completely unfolded angle α2 of 180° as illustrated in FIG. 4c.

### Sixth Embodiment

For each time, before 9:30, 9:30, 11:30, 13:30, and after 13:30, the angles α1 and α2 of the first reflection plate 210 and the second reflection plate 220 are adjusted. The angle α1 between the first reflection plate 210 and the top surface of the solar cell panel 100 maintains 180° before 9:30, 140° from 9:30 to 11:30, 100° from 11:30 to 13:30, and 100° after 13:30. Also, the angle α2 between the second reflection plate 220 and the top surface of the solar cell panel 100 maintains 180° before 9:30, 140° from 9:30 to 11:30, 100° from 11:30 to 13:30, and 100° after 13:30.

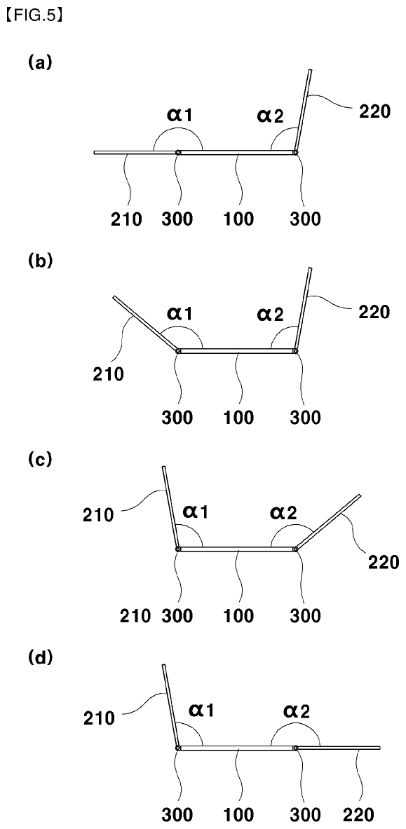

The method for varying the angle of the reflection plate is illustrated for each step in FIG. 5. The angle between the first reflection plate and the second reflection plate before 9:30 is illustrated in FIG. 5a, the angle from 9:30 to 11:30 is illustrated in FIG. 5b, the angle from 11:30 to 13:30 is illustrated in FIG. 5c, and the angle after 13:30 is illustrated in FIG. 5d.

### Seventh Embodiment

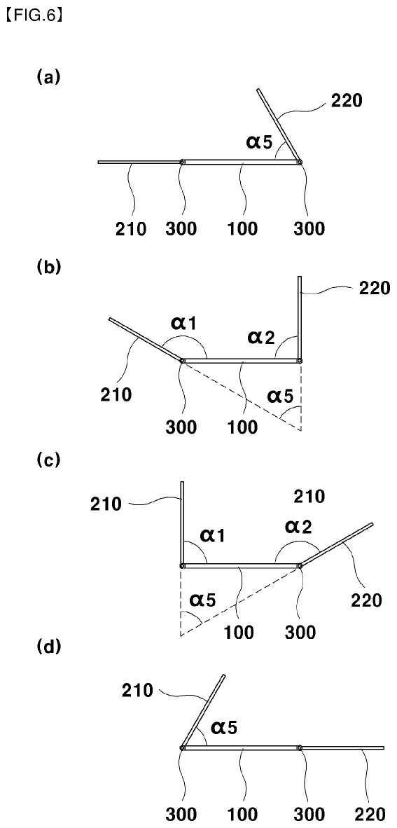

The first reflection plate 210 and the second reflection plate 220 rotate to have maximum illuminance according to movement of a solar path in a state in which an internal angle α5 between the first reflection plate 210 and the second reflection plate 220 is maintained to be 60° by using the solar cell module according to the third embodiment. This is illustrated in FIG. 6. That is, the internal angle α5 between the first reflection plate 210 and the second reflection plate 220 is maintained to be 60° while varying the angle α1 between the first reflection plate 210 and the solar cell panel 110 and the angle α2 between the second reflection plate 220 and the solar cell panel 110 to be different from each other according to a variation of the solar path as in FIGS. 6a to 6d.

### First Comparative Example

The solar-light power generation is performed under the same environment as the present invention in a state in which the reflection plate is not installed on the solar cell panel for comparison with the embodiments 4 to 7 of the present invention.

### Second Comparative Example

In a second comparative example, the power generation is performed in a state in which the angle between the top surface of each of the first reflection plate 210 and the second reflection plate 220 and the top surface of the solar cell panel 100 is fixed to 120° regardless of the solar path by using the solar cell module according to the first embodiment.

Results obtained after the solar-light power generation according to each of the embodiments 4 to 7 and the comparative examples 1 and 2 is performed are shown in table 1 below. In the table 1 below, a rate of increase (%) represents a power generation quantity increased in comparison with the comparative example 1 in which the reflection plate is not installed on the solar cell panel.

TABLE 1

| | Comparative | Comparative | Embodiment | Embodiment | Embodiment | Embodiment |
|---|---|---|---|---|---|---|
| Classification | example 1 | example 2 | 4 | 5 | 6 | 7 |
| Rate of | — | −1.2~3.1 | 14.6~15.5 | 21.6~24.3 | 22.6~25.6 | 27.5~33.9 |
| increase | | | | | | |
| (%) | | | | | | |

As shown in the table 1 above, it may be known that the power generation quantity of the embodiments 3 to 7 in which the angle of the reflection plate is varied according to the variation of the solar path increases in comparison with the Comparative example 2 in which the reflection plate is not installed or the angle of the reflection plate is fixed. Particularly, it may be known that the power generation quantity of the embodiment 7 in which the angle of the reflection plate is varied a plurality of times so that the solar light has greatest illuminance remarkably increases.

### Eighth Embodiment

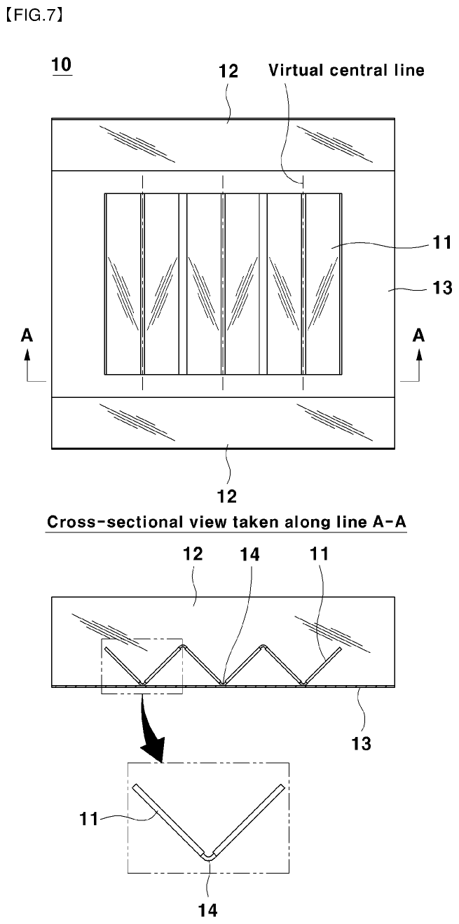

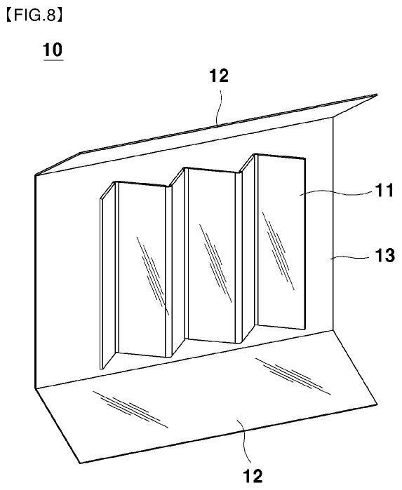

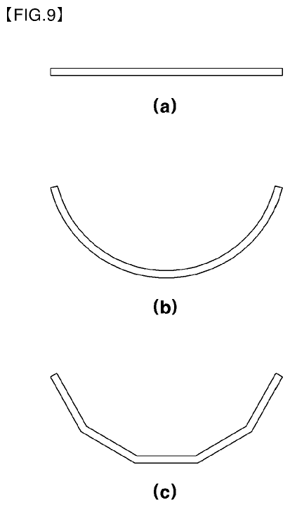

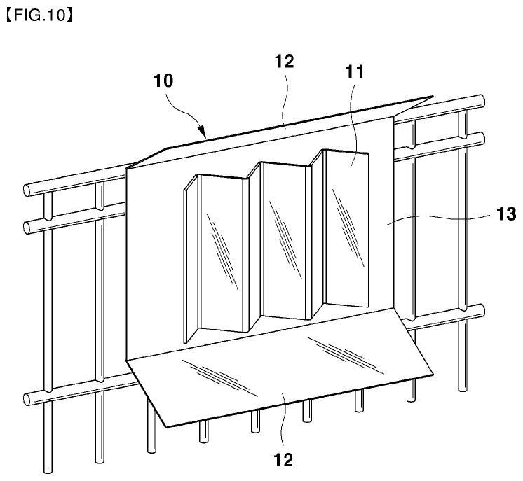

FIG. 7 is a plan view and a side view of a solar cell module according to an eighth embodiment of the present invention, FIG. 8 is a perspective view of the solar cell module according to the eighth embodiment of the present invention, FIG. 9 is a view exemplarily illustrating a shape of the reflection plate attached to the solar cell module, and FIG. 10 is a view illustrating a state in which the solar cell module according to the eighth embodiment of the present invention is installed on a structure such as a fence.

As illustrated in FIGS. 7 to 10, a solar cell module 10 according to the eighth embodiment of the present invention includes a plurality of solar cell panels 11, a reflection plate 12, and a support 13.

The plurality of solar cell panels 11 are arranged to face each other in such a manner that an internal angle between a solar-light incident surface of one panel and a solar-light incident surface of another panel adjacent thereto form a predetermined angle (about 90° in the drawing).

Also, as illustrated in FIG. 8, each of the solar cell panels 11 is fixed to the support 13 through a connection member 14 extending in a longitudinal direction thereof while forming a predetermined angle by a method such as welding or coupling by a bolt.

Although the angle between the solar cell panels 11 is set to about 90° in the eighth embodiment of the present invention, an angle (θ1) between the adjacent solar cell panels 11 may be adjusted in a range greater than 0° less than 180°.

Also, the connection member 14 may physically connect the solar cell panels 11 and simultaneously allow the solar cell panels 11 to be bent. For example, a mechanical rotating unit such as a hinge for mechanically connecting in a bendable state may be used. For another example, a method for connecting the solar cell panels 11 in a bendable manner by disposing a flexible member such as plastic or fibers between the adjacent solar cell panels 11 and then attaching ends thereof by using a unit such as an adhesive, a bolt and a nut, and a Velcro. Also, a wire for connecting electricity generated from the solar cell panel 11 may be disposed in the connection unit 14.

Also, the angle between the solar cell panels 11 may be controlled through an electrical signal by a method for fixing a shaft and the solar cell panels 11 to the shaft in a rotatable manner by using the connection member 14 and then adjusting the angle of the rotatably connected solar cell panels 11 through a driving unit such as a motor.

The reflection plate 12 is fixed to be inclined at a predetermined angle to the support 13 in a state of contacting or being spaced a predetermined distance from one end of the solar cell panel 11 in order to cross a central line (a virtual central line) between the solar cell panels 11 facing each other. The reflection plate 12 inclined as described above reflects incident solar light toward the solar cell panel 11 to increase a power generation efficiency of the solar cell panel 11.

A reflection surface, which is a surface of the reflection plate 12, may include a metal mirror surface, a glass mirror surface, or a plastic mirror surface to easily reflect the solar light. Alternatively, the reflection surface of the reflection plate 12 may be a transparent flat plate such as acryl or glass, on which a reflection material forms a predetermined pattern.

The pattern of the reflection material may be formed on a transparent substrate by using a coating method such as deposition using vacuum deposition or screen printing. In addition, a method for attaching a metal foil on a transparent substrate may be applied.

Here, since the substrate of the reflection plate 12 has a thermal resistance, an insulating material capable of restricting temperature increase may be used.

Also, a plurality of holes having various shapes may be formed in the reflection plate 12, and these holes allows win to flow therethrough and thus reduce a pressure applied to the panel and the reflection plate, thereby reducing a damage risk of the solar cell module caused by strong wind.

As illustrated in FIGS. 9a and 9b, a shape of the reflection plate 12 may be formed by a flat plate, a curved surface having a predetermined curvature, a plurality of bent surfaces, or a combination thereof.

Although the solar cell module 10 according to the eighth embodiment of the present invention may be installed on a separate holder, the solar cell module 10 may be directly installed on a metallic structure of a building or an apartment without the holder as illustrated in FIG. 10.

### Ninth Embodiment

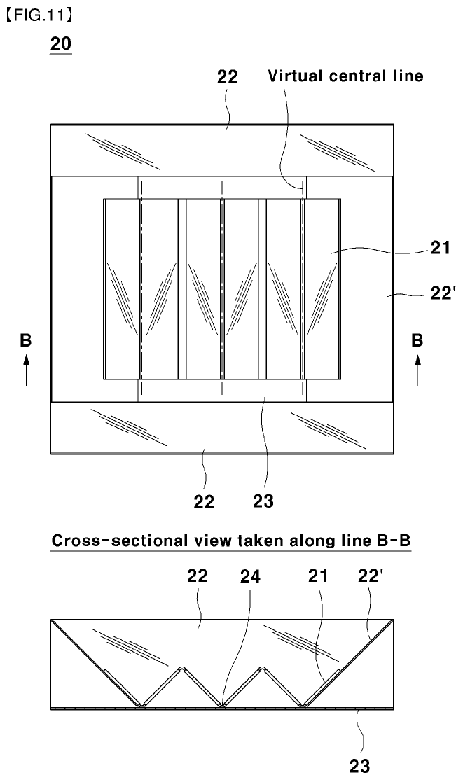

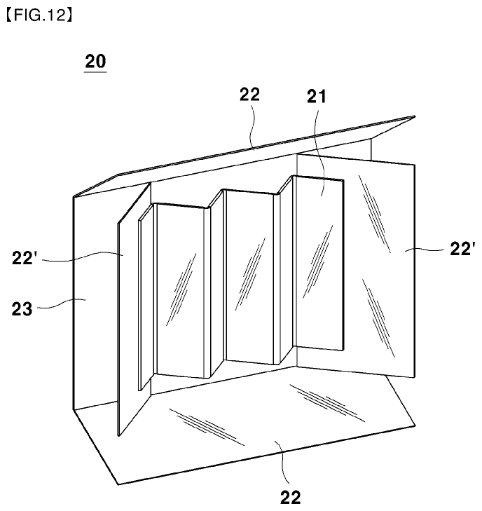

FIG. 11 is a plan view and a side view of a solar cell module according to a ninth embodiment of the present invention, and FIG. 12 is a view illustrating a state in which the solar cell module according to the ninth embodiment of the present invention is installed on a structure such as a fence.

As illustrated in FIGS. 11 and 12, a solar cell module 20 according to the ninth embodiment of the present invention is characterized by additionally arranging a reflection plate 22′ on each of both ends of the arranged solar cell panels 21 in a direction parallel to a virtual central line to the solar cell module according to the eighth embodiment of the present invention.

The reflection plate 22′ has one side fixed in a method of lengthily extending from a rear surface of each of the both ends of the solar cell panel 21 to have the substantially same inclined angle as an inclined angle of the solar cell panel 21 and the other side fixed to the support 23 by using a coupling unit (not shown).

As described above, when the solar light is reflected in all of four directions, the power generation efficiency of the solar cell panel 21 may further improve.

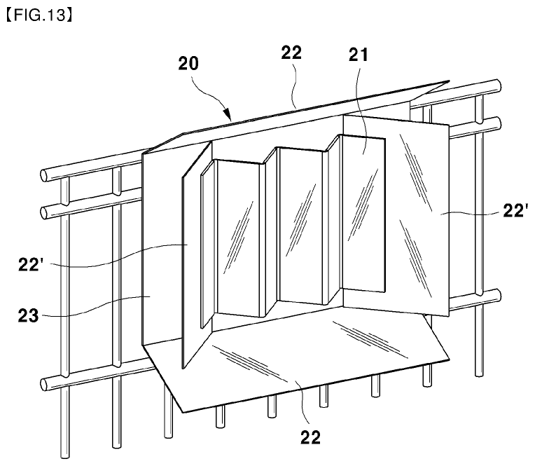

Although the solar cell module 20 according to the ninth embodiment of the present invention may be also used to be installed on a separate holder, the solar cell module 20 may be directly installed on a metallic structure of a building or an apartment without the holder as illustrated in FIG. 13.

### Tenth Embodiment

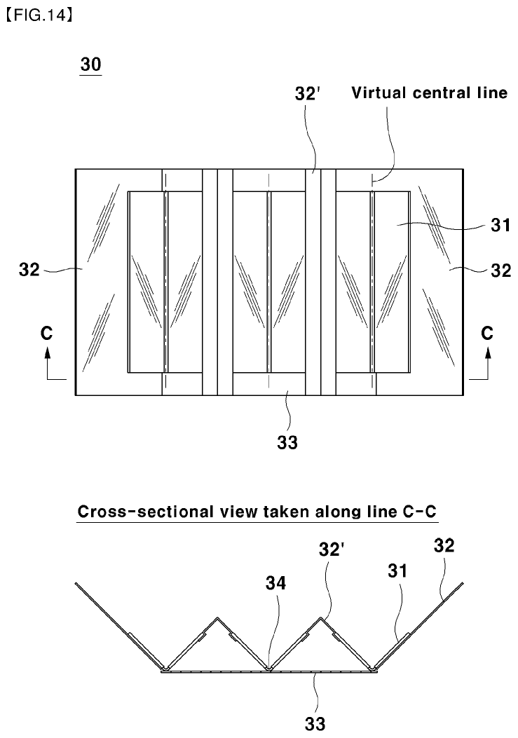

FIG. 14 is a plan view and a side view of a solar cell module according to a tenth embodiment of the present invention.

As illustrated in FIG. 14, a solar cell module 30 according to the tenth embodiment of the present invention is configured such that two adjacent solar cell panels 31 face each other in a V-shape, reflection plates 31 are arranged in a direction parallel to a virtual central line of the solar cell panel 31, and a support 33 for supporting the solar cell panels 31 is provided in the solar cell module according to the eighth embodiment of the present invention. Also, the solar cell module 30 is characterized by additionally arranging a A-shaped reflection plate 32′ extending lengthily in a longitudinal direction thereof between a V-shape and a V-shape after the V-shape and the V-shape of the plurality of solar cell panels 31 instead of being directly connected.

Although the reflection plate 32′ is fixed to an upper end of the solar cell panel 31 and forms the A-shape, the embodiment of the present invention is not limited to the shape of the reflection plate 32′. As described above, reflected light of the solar light may be provided uniformly between the solar cell panels 31 by the added reflection plate 32′.

### Eleventh Embodiment

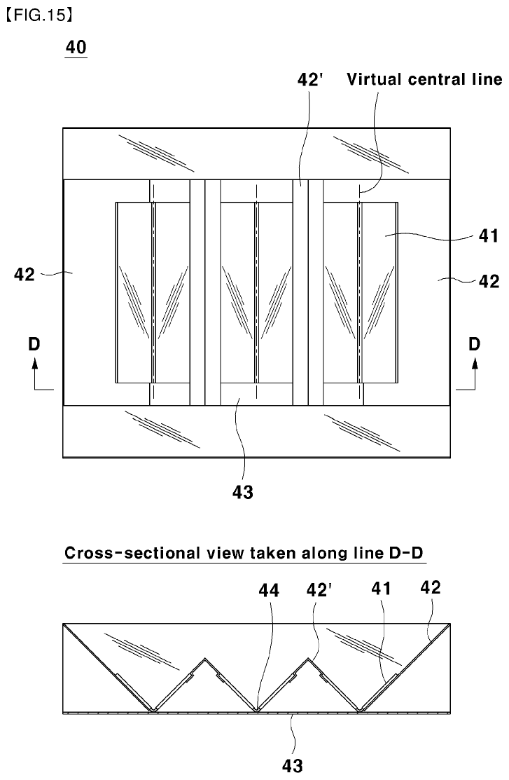

FIG. 15 is a plan view and a side view of a solar cell module according to an eleventh embodiment of the present invention.

As illustrated in FIG. 15, a solar cell module 40 according to the eleventh embodiment of the present invention is characterized by additionally arranging a reflection plate 42 crossing a virtual central line in the solar cell module according to the tenth embodiment of the present invention.

### Twelfth Embodiment

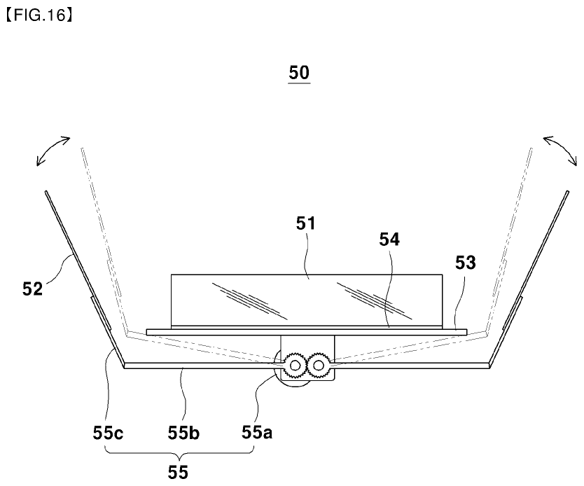

FIG. 16 is a side view illustrating a solar cell module according to a twelfth embodiment of the present invention.

As illustrated in FIG. 16, a solar cell module 50 according to the twelfth embodiment of the present invention allows an installation angle of the reflection plate 12 in the solar cell module according to the eighth embodiment of the present invention to be adjusted by using a motor.

The solar cell module 50 according to the twelfth embodiment of the present invention includes a plurality of solar cell panels 51, a reflection plate 52, a support 53 for supporting the solar cell panels 5, a connection member 54 of the solar cell panels, and an angle adjusting unit 55 for adjusting an angle of the reflection plate 52.

In the solar cell module 50 according to the twelfth embodiment of the present invention, the reflection plate 52 is not fixed to the support 53 to adjust the angle unlike the first embodiment.

Also, the angle adjusting unit 55 include a motor 55a fixed to one side of the support 53, a plate-shaped first angle adjusting member 55b connected to the motor 55a in a rotatable manner, and a second angle adjusting member 55c fixed to the first angle adjusting member 55b to form a predetermined angle and determining a base inclined angle of the reflection plate 52.

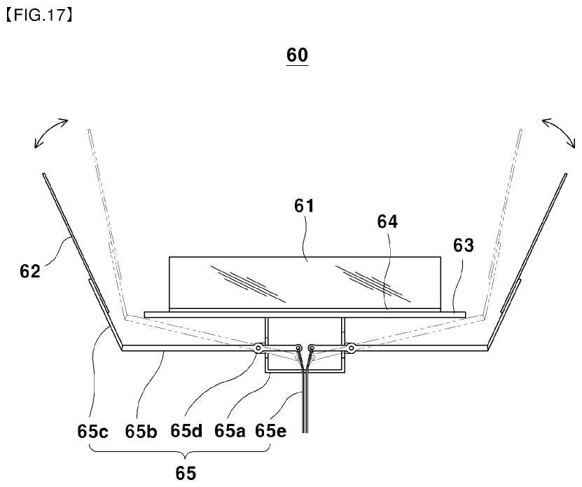

As illustrated in FIG. 17, an inclination of the reflection plate 52 with respect to the solar cell panel 51 may be varied through a process of increasing or decreasing an angle with the first angle adjusting member 55b through an operation of the motor 55a.

Through this, an optimized state may be maintained by adjusting a quantity of light incident to the solar cell panel 51 through the reflection plate 52 and adjusting an inclination of the reflection plate 52 in consideration of the altitude of the sun. Here, the motor 55a may be controlled in a wired or wireless manner by using a computer including a calculation unit and a storage unit. When wireless control is necessary, a receiving unit capable of receiving a control signal in the wireless manner may be provided to the motor. As the motor 55a operates by providing the control signal for each predetermined time based on at least one piece of information selected from the altitude of the sun, a sunrise time, and a sunset time, which are stored in the storage unit, the reflection plate 52 may be adjusted to have an optimized inclined state at the corresponding time zone.

Although the solar cell module 50 according to the twelfth embodiment of the present invention has a structure of increasing or decreasing the angle between the reflection plates 52 through the motor 51, a method for controlling the inclination by rotating two first angle adjusting members 55b for fixing the reflection plate in one direction may adjust the angle instead of adjusting the angle between the reflection plates 52.

### Thirteenth Embodiment

FIG. 17 is a side view of a solar cell module according to a thirteenth embodiment of the present invention.

As illustrated in FIG. 17, a solar cell module 60 according to the thirteenth embodiment of the present invention allows an installation angle of the reflection plate 12 in the solar cell module according to the eighth embodiment of the present invention to be adjusted manually.

The solar cell module 60 according to the thirteenth embodiment of the present invention includes a plurality of solar cell panels 61, a reflection plate 62, a support 63 for supporting the solar cell panels 61, a connection member 64 of the solar cell panels, and an angle adjusting unit 65 for adjusting an angle of the reflection plate 62.

The angle adjusting unit 65 include a housing 65a having one side fixed to the support 63, a bar-shaped first angle adjusting member 65b supported by the housing 65a in a rotatable manner, and a second angle adjusting member 65c fixed to the first angle adjusting member 65b to form a predetermined angle and determining a base inclined angle of the reflection plate 62.

The reflection plate 62 is fixed to one end of the second angle adjusting member 65c through a coupling unit such as a bolt or an attaching unit such as an adhesive instead of being fixed to the support 63 for angle adjustment unlike the eighth embodiment.

A rotation support 65d for supporting the first angle adjusting member 65b in a rotatable manner is arranged on each of both sides of the housing 65a, and an angle adjusting rope 65e is connected to an end of the first angle adjusting member 65b.

The solar cell module 60 according to the thirteenth embodiment of the present invention may differently adjust an angle of the first angle adjusting member 65b supported by the rotation support 65d by releasing or pulling the angle adjusting rope 65e and, through this, adjust an inclination of the reflection plate 62 connected thereto.

1. A solar cell module comprising a solar cell panel and a reflection plate connected to and disposed on an edge of the solar cell panel, wherein an angle between the reflection plate and a surface of the panel is varied.

2. The solar cell module of claim 1, wherein the reflection plate comprises a first reflection plate disposed at the east and a second reflection plate disposed at the west when the panel faces the south, and an angle between a surface of the panel and a surface of the first reflection plate and an angle between the surface of the panel and a surface of the second reflection plate are simultaneously or individually varied.

3. The solar cell module of claim 1, wherein the variable angle is varied along a solar path variation.

4. The solar cell module of claim 1, wherein the angle is varied in a range from 60° to 180°.

5. The solar cell module of claim 1, wherein the reflection plate has a width greater than that of the panel.

6. The solar cell module of claim 1, wherein the reflection plate comprises one or both of a third reflection plate connected to and disposed on an upper edge of the panel and a fourth reflection plate connected to and disposed on a lower edge of the panel.

7. The solar cell module of claim 6, wherein an angle between the surface of the panel and a surface of the third reflection plate and an angle between the surface of the panel and a surface of the fourth reflection plate are simultaneously or individually varied.

8. The solar cell module of claim 1, wherein the solar cell module further comprises an illuminance sensor, and as a motor configured to vary the angle is connected to the reflection plate, the motor is driven to rotate the reflection plate so that illuminance is maximized by using the illuminance sensor.

9. A method for adjusting the reflection plate of the solar cell module according to claim 1, comprising adjusting the angle so that solar light is always incident to a surface of the reflection plate.

10. The method of claim 9, further comprising:
maintaining an angle of the surface of each of the first and second reflection plates with the surface of the panel to be 180° before 10 o'clock in the morning,
maintaining an angle of the surface of each of the first and second reflection plates with the surface of the panel to be 120° from 10 o'clock in the morning to 2 o'clock in the afternoon, and
maintaining an angle of the surface of each of the first and second reflection plates with the surface of the panel to be 180° after 2 o'clock in the afternoon.

11. The method of claim 9, further comprising:
maintaining an angle of the first reflection plate with the surface of the panel to be 180° and an angle of the second reflection plate with the surface of the panel to be 120° before 10 o'clock in the morning,
maintaining an angle of each of the first and second reflection plates with the surface of the panel to be 120° from 10 o'clock in the morning to 2 o'clock in the afternoon, and
maintaining an angle of the first reflection plate with the surface of the panel to be 120° and an angle of the second reflection plate with the surface of the panel to be 180° after 2 o'clock in the afternoon.

12. The method of claim 9, wherein the angle is adjusted so that an internal angle between the first reflection plate and the second always forms 60°, and the solar light is always incident to the surface of the reflection plate.

13. The solar cell module of claim 1, wherein two or more solar cell panels are provided, and
the reflection plate is disposed at one side or both sides of the solar cell panels in a direction crossing a virtual central line between the two or more solar cell panels.

14. The solar cell module of claim 1, wherein two or more solar cell panels are provided,
the two or more solar cell panels are arranged to face each other such that a solar-light incident surface of one solar cell panel is inclined at a predetermined angle to a solar-light incident surface of another solar cell panel, and
the reflection plate is disposed at one side or both sides of the solar cell panels facing each other in a direction crossing a virtual central line between the solar cell panels facing each other.

15. The solar cell module of claim 13, further comprising a reflection plate disposed on one or all of both edges of the two or more solar cell panels that are consecutively arranged in a direction parallel to the virtual central line.

16. The solar cell module of claim 14, wherein the predetermined angle is greater than 0° and less than 180°.

17. The solar cell module of claim 14, wherein in the two or more solar cell panels, one ends of two adjacent solar cell panels are connected through a connection shaft, and the reflection plates arranged in the direction crossing the virtual central line contact each other at the connection shaft or are spaced a predetermined distance from each other.

18. The solar cell module of claim 13, wherein the two or more solar cell panels comprise a support configured to support the reflection plate.

19. The solar cell module of claim 13, wherein the two or more solar cell panels are connected in the form of ∧ or ∨, and
as the solar cell panels connected in the form of ∧ or ∨ are arranged so that one of the ∧ shape and the ∨ shape is consecutively arranged or both of the ∧ shape and the ∨ shape are mixed, the solar-light incident surfaces face each other.

20. The solar cell module of claim 19, wherein the reflection plate is additionally disposed on a portion connected in the form of ∧ or ∨.

21. The solar cell module of claim 13, wherein the reflection plate has a shape of one of a flat surface, a curved surface, or a bent surface, or a combination thereof.

22. The solar cell module of claim 13, further comprising an angle adjusting unit configured to adjust an inclination of the reflection plate.

23. The solar cell module of claim 14, further comprising a reflection plate disposed on one or all of both edges of the two or more solar cell panels that are consecutively arranged in a direction parallel to the virtual central line.

24. The solar cell module of claim 14, wherein the two or more solar cell panels comprise a support configured to support the reflection plate.

25. The solar cell module of claim 14, wherein the two or more solar cell panels are connected in the form of ∧ or ∨, and
as the solar cell panels connected in the form of ∧ or ∨ are arranged so that one of the ∧ shape and the ∨ shape is consecutively arranged or both of the ∧ shape and the ∨ shape are mixed, the solar-light incident surfaces face each other.

26. The solar cell module of claim 14, wherein the reflection plate has a shape of one of a flat surface, a curved surface, or a bent surface, or a combination thereof.

27. The solar cell module of claim 14, further comprising an angle adjusting unit configured to adjust an inclination of the reflection plate.
